(19) United States
(12) Patent Application Publication
(10) Pub. No.: US 2016/0374309 A1
(43) Pub. Date: Dec. 29, 2016

(54) Support Base for a Vertical Structure

(71) Applicant: Ronald D. Weingart, Agoura Hills, CA (US)

(72) Inventor: Ronald D. Weingart, Agoura Hills, CA (US)

(21) Appl. No.: 14/750,130

(22) Filed: Jun. 25, 2015

(51) Int. Cl. A01K 1/03; F16M 11/22; F16M 11/04

(52) U.S. Cl. CPC A01K 1/034; F16M 11/04; F16M 11/22; A01K 1/03

(57) ABSTRACT

A support base for a vertical section, wherein the base comprises an upper surface, a lower surface and a perimeter edge. The upper surface has at least two slots into each of which is inserted a lower edge of the vertical section, thereby maintaining the vertical section in an upright position. Multiple support bases are used in combination with multiple vertical sections to assemble a geometric structure that is placed upon a substantially flat surface, and is typically utilized as an animal enclosure, which is particularly effective as a dog enclosure.

### DISCLOSURE OF THE INVENTION

In its basic design, the invention discloses a support for a vertical panel support. The base comprises an upper sharp corners/edges that an animal might chew on, a lower surface (or edge if the base is hollow), and a perimeter edge. The support can be any geometric or non-geometric shape surface, preferably domed to eliminate or reduce but is preferably circular and can be made of plastic, vinyl, hard rubber, wood, metal or other material. The support's upper surface has at least one slot. Each vertical panel is comprised of an upper edge, a lower edge, a first side edge and a second side edge. A portion of the panel's lower edge is inserted into the slot on the support's upper surface, once inserted, the panel is maintained in an upright position. The panel can be inserted at its midpoint or may also be inserted at its first edge half-way into a slot and its second edge halfway into a slot on a second base. Multiple supports can be utilized in combination with multiple individual or joined vertical sections to create various shaped structures. There are multiple applications for which such structures can be employed but the primary use of the structure is to form an enclosure for animals or pets such as dogs.

In view of the above disclosure, the primary object of the invention is to provide a support that can be quickly and easily utilized to assemble and maintain a modular enclosure that consists of a plurality of interlocking vertical panels.

In addition to the primary object of the invention it is also an object of the invention to provide a support that:
is easy to use,
can accommodate vertical panels of various sizes,
can utilize a single support with multiple slots to create an enclosure selected from various shapes,
can be made in a variety of sizes,
has an upper domed surface that deters dogs from chewing on the edge(s) of the base,
can be easily stored and transported,
can be used indoors and outdoors,
can be sold individually, or as part of a complete kit to assemble an animal enclosure,
can be used repeatedly to assemble different shaped structures,
is cost effective from both a manufacturer's and consumer's point of view,
protects interior flooring, and
raises an enclosure off the floor so that the enclosure does not come in contact with liquid that is spilled on the floor.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an elevation side view of a support base showing one slot and a domed upper surface.

FIG. 2 is a top plan view of the support base with a single extended slot for supporting either a single panel or two adjacent panels in a straight line.

FIG. 3 is an elevation side view of a support base for a vertical section panel having at least one slot and a non-domed upper surface.

FIG. 4 is a top plan view of a support having two slots fully extended in a 90-degree cross-way configuration to support two or more panels in a straight line and/or at a 90-degree angle.

FIG. 5 is a top plan view of the support having two radiating slots in a right angle orientation to support two panels at a right angle, i.e., 90-degrees.

FIG. 6 is an elevation view of a support having at least one extended slot and with a vertical panel inserted at its mid-point.

FIG. 7 is an elevation side view of a support having at least one extended slot and with two adjacent vertical panels inserted at the end of one panel and the beginning of the other.

FIG. 8 is an elevation side/end view of a support having two slots at 90-degree and with two adjacent vertical panels with their ends meeting at the center forming a 90-degree angle.

FIG. 9 is a top plan view of an equilateral triangular support having three radiating slots with an included angle of 120-degrees between one another to support two or more panels at 120-degrees.

FIG. 10 is a top plan view of an equilateral triangular support with three slots to support at least two panels at multiple orientations and included angles of 120-degrees and 60-degrees.

FIG. 11 is a top plan view of a square support having two extended slots in cross-way orientation to support at least two panels in multiple orientations.

FIG. 12 is a top plan view of a square support having four extended slots in two cross-way orientations to support at least two panels in multiple orientations.

FIG. 13 is a top plan view of a pentagonal support having five extended slots in three cross-way orientations to support at least two panels in multiple orientations.

FIG. 14 is a top plan view of a hexagonal support having four extended slots to support at least two or more panels in multiple orientations.

FIG. 15 is a top plan view of an octagonal support with two extended slots in cross-way orientations to support at least two panels in multiple orientations.

FIG. 16 is a top plan view of an octagonal support with four extended slots in two cross-way orientations to support at least two or more panels in multiple orientations.

FIG. 17 is a top plan view of a circular support having four extended slots in two cross-way orientations.

FIG. 18 is a top plan view of a four slots, with one slot in a 90 degree orientation to one extended slot, one slot at a 45 degree angle from the extended slot, and one slot at a 60 degree angle from the extended slot.

FIG. 19 is a top plan view of eight into six panel round support with a triple wide slot, and two slots each at a 60 degree angle from an extended slot.

FIG. 20 is a top plan view of eight supports and eight panels in a square enclosure configuration.

FIG. 21 is a top plan view of eight supports and eight panels in a rectangular enclosure configuration.

FIG. 22 is a top plan view of eight supports and eight panels in an “L” enclosure configuration.

FIG. 23 is a top plan view of eight supports and eight panels in a dual square enclosure configuration.

FIG. 24 is a top plan view of eight supports and eight panels in an octagonal enclosure configuration.

FIG. 25 is a top plan view of six supports and six panels in a triangular enclosure configuration.

FIG. 26 is a top plan view of six supports and six panels in a rectangular enclosure.

FIG. 27 is a top plan view of six supports and six panels in a hexagonal enclosure.

FIG. 28 is an elevation side view of the supports showing a non-slip/anti-slip material attached to the lower surface/edge of the base.

### BEST MODE FOR CARRYING OUT THE INVENTION

The best mode for carrying out the invention is presented in terms that disclose a preferred embodiment with multiple design configurations of a support for a vertical panel.

Throughout the world, men and women keep animals for a variety of reasons. One of the most common reasons for keeping an animal is as a pet, and usually pets are either cats or dogs. It is widely accepted that cats require less attention than dogs. It is also a known fact that certain types/breeds of dogs, as well as puppies, can require more attention than others. As a result of the popularity of having a pet, many products have been developed to assist pet owners.

A situation that occurs frequently for pet owners, especially dog owners, is the need to maintain the pet in a specific location, either indoors or outdoors. To provide a solution to this problem, animal/pet enclosures have been developed. An enclosure typically consists of multiple interfacing “walls” that are attached together to create the enclosure. Unfortunately, there are problems/deficiencies in this type of enclosure paradigm. One of the problems is that many enclosures must be held in place by stakes that are driven into the ground. This method is acceptable for use outdoors on soil, but is not feasible for hard surfaces such as patios or driveways or for indoor use where there're there is no ground into which the stakes can be driven. Also, typical prior art enclosures often experience difficulty in maintaining their shape and/or position, thereby requiring that they are repeatedly re-arranged, re-positioned and even re-assembled. The instant support base provides a solution to these problems/deficiencies by providing a support that can be used indoors or outdoors on both ground/soil and hard surfaces. The support does not require stakes and will not scuff a wood or interior floor, and can be used to assemble an enclosure having a selected size and shape.

The support 10 for a vertical panel 30 provides an easy and quick means for a single person to assemble and disassemble, relocate, and/or reassemble an enclosure for animals/pets, which is especially effective for use as a dog enclosure. For the purpose of this disclosure, dog(s) will be used as the referenced animal/pet.

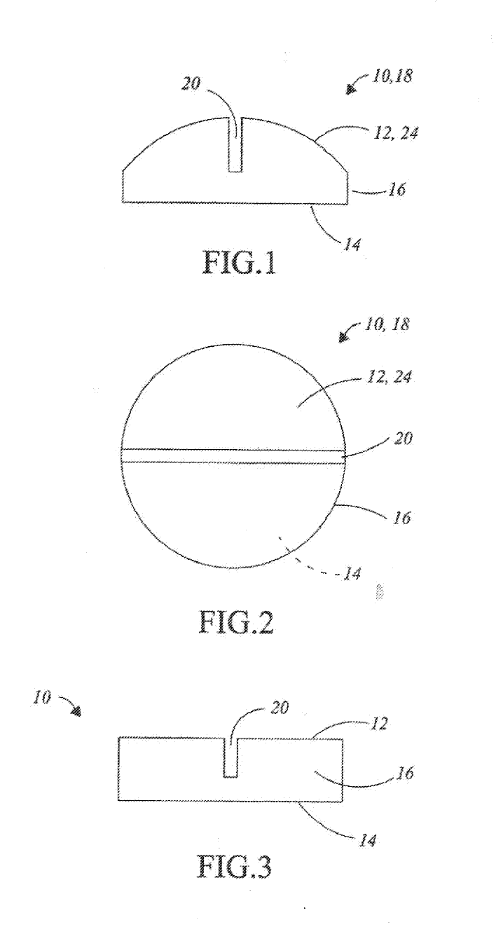

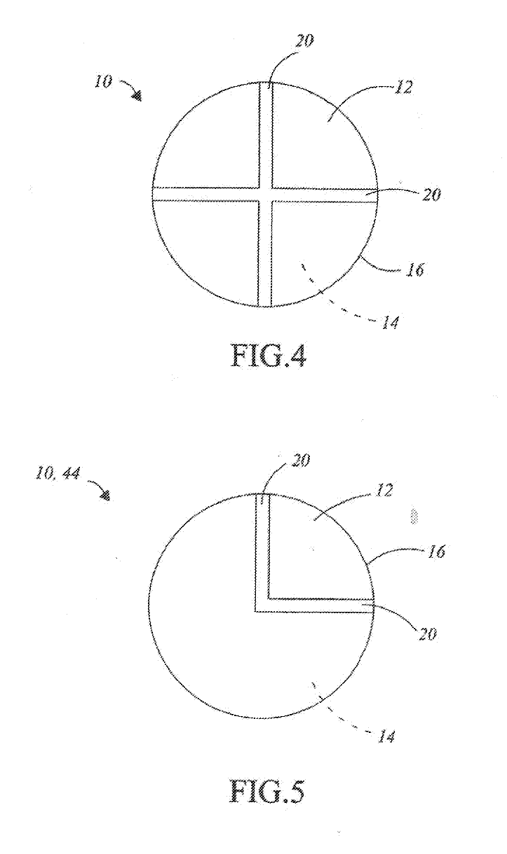

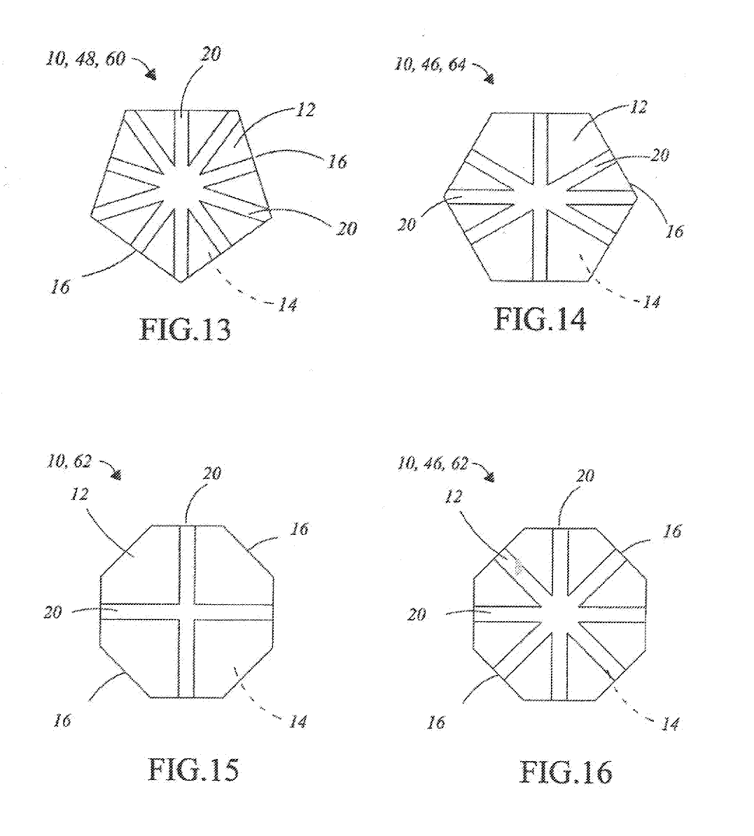

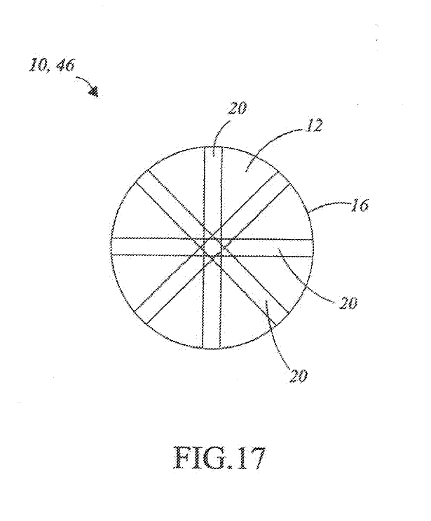

The support 10, as shown in FIGS. 1-28, is comprised of the following elements: an upper surface 12, a lower surface 14 and a perimeter edge 16. The support 10 can be solid or hollow and is made of a material selected from the group consisting of plastic, wood or metal. The support can be any geometric shape including circular 18, as shown in FIGS. 1 and 2; triangular 56, as shown in FIGS. 9 and 10; square 58, as shown in FIGS. 5, 11 and 12; pentagonal 60, as shown in FIG. 10; hexagonal 64, as shown in. FIG. 14; or octagonal 62, as shown in FIGS. 15 and 16. FIG. 9 shows an equilateral triangular support with three radiating slots having an angle of 120-degrees between one another to support at least two adjacent panels at 120-degrees. Additionally, as shown in FIG. 10, a triangular support can be used to support two panels at multiple orientations with angles of 120-degrees and 60-degrees.

The preferred shape of the support 10 is circular 18. Additionally, a circular shape facilitates the support having a domed upper surface 24, as shown in FIGS. 1 and 2. The domed upper surface 24 is preferred because it acts as a deterrent to keep dogs from chewing (and subsequently damaging) the perimeter edge of the support.

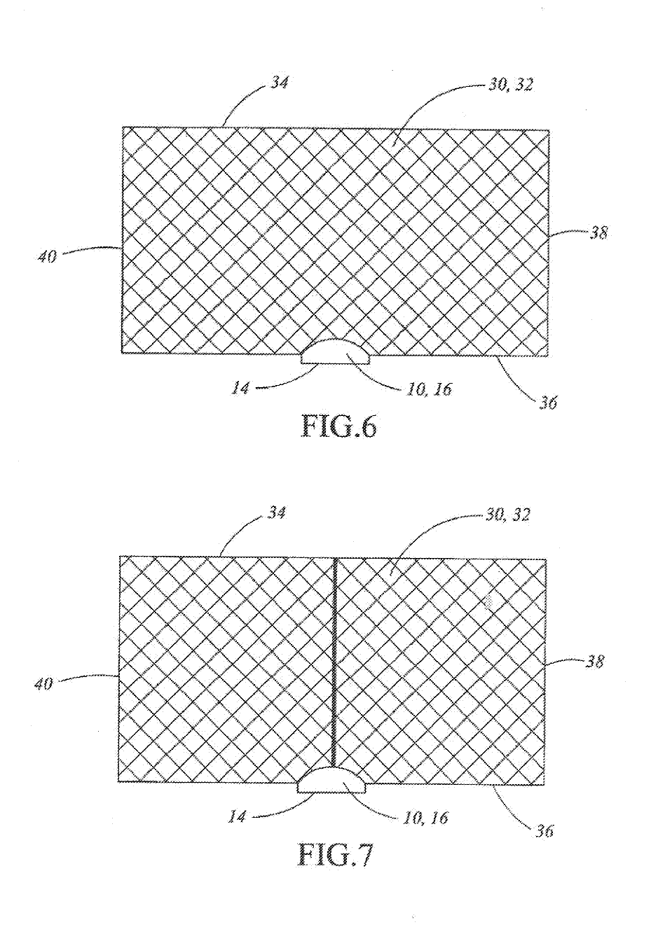

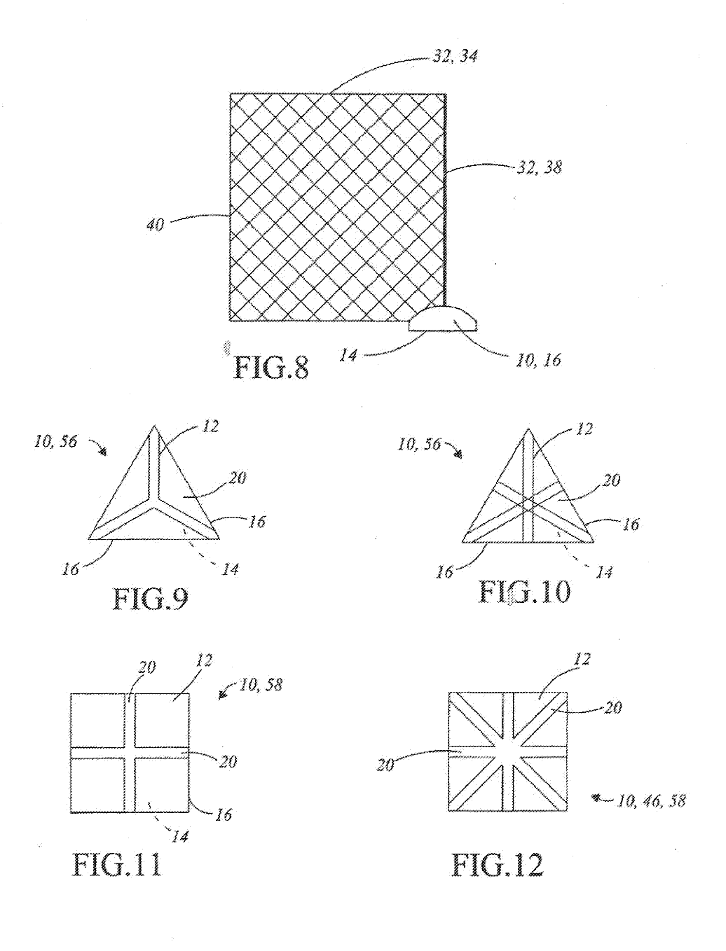

The support 10 functions in combination with a plurality of vertical sections 30 which is are each typically in the form of a panel 32. The preferred shape of the panel 32 is square or rectangular and the panel is comprised of an upper edge 34, a lower edge 36, a first side edge 38 and a second side edge 40. A single panel 32 inserted into a single extended slot, is shown in FIG. 6. As shown in FIG. 7, two slots at 90-degrees are utilized to support two adjacent panels inserted at the end of one panel and the beginning of the other. FIG. 8 shows a support having two slots at 90-degrees that are utilized to support two adjacent panels with their ends meeting at the center to form a 90-degree angle. The panel which is made of plastic, wood, metal or a combination of materials such as a metal, plastic or wood frame surrounding a fabric, can be a solid panel or is preferably a mesh or other similar design that allows a person to view the dog(s) within the enclosure, and allows the dog(s) to see the environment surrounding the enclosure. The support 10, whatever shape, is utilized to support at least one panel in a single or multiple orientations, as shown in FIGS. 6, 7 and 8.

It should be noted that while any of the previously disclosed panel shapes and designs can be utilized, the support 10 is particularly effective when used with a conventional rectangular shaped panel that consists of two square or rectangle panels which are hinged together. The attachment facilitates one or both of the two panels being folded to produce various angles, which determine the shape of the enclosure.

The upper surface 12 of the support 10 has at least one slot two slots 20, as shown in FIGS. 1-5, 9-19. Each slot is typically utilized to support either a single panel or two adjacent panels in a straight line. As previously disclosed, when two panels are used, the panels are inserted at the end of one panel interfacing with the beginning of another panel, as shown in FIG. 7. In another embodiment, at least two slots 20 in a cross-way orientation are located in a base with a domed upper surface 24, as shown in FIGS. 1 and 2. The width of each slot 20 depends on the width of the panel 32 inserted therein. A width of ¼-inch has shown to be compatible with most commercially available metal wire panels. Additionally, as shown in FIG. 19, wider slots, for example ¾-inch or 1-inch wide, can be utilized to facilitate the insertion of multiple panels into a single slot 20. The cross-way orientation is utilized to support at least two adjacent panels in a straight line and/or at 90-degree right angle. In addition to a single slot or two slots in cross-way orientation, other variations of slot placement include two slots 20 in an “L” configuration 44, as best shown in FIG. 5. The “L” configuration 44 is utilized to two adjacent panels at a 90-degree right angle.

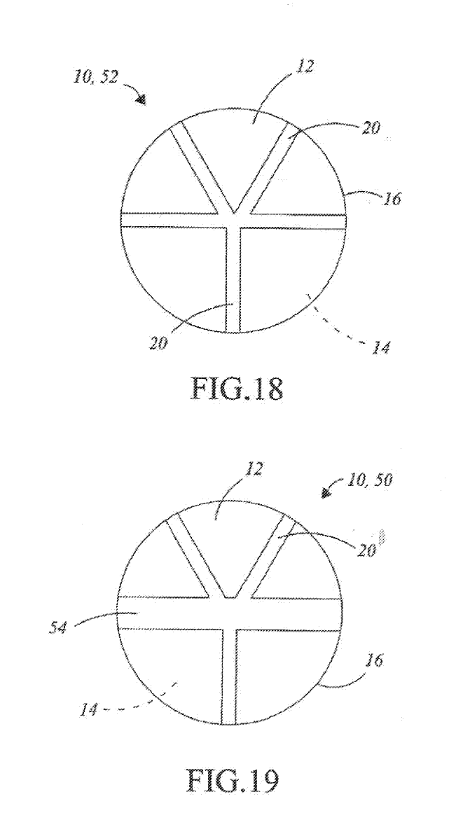

A special eight into six panel slots support, is shown in FIG. 19. The eight into six design can include one wider slot, which is preferably ¾-inch wide and capable of accepting three panels accordion-folded against each other, and three slots in a “Y” configuration, with the two angled slots having a 30-degree angle, as shown in FIG. 19. Two of these special supports are used with the combination base, as shown in FIG. 18, to form an eight into six panel enclosure, an octagon or a triangle or rectangle. Six of the special eight into six supports may be used to form an octagon.

On casual observation, the combination eight and six slots support design is similar to the eight into six slots support design. The combination eight and six slots support does not include a wider slot, and the two angled slots each respectively have an angle of 45 degrees to form a 135 degree included angle with the vertical slot, and a 30 degrees slot to form a 120 degree included angle with the horizontal slot. The 135 degrees angled slot is utilized for an eight panel octagonal enclosure, and the 120 degrees angled slot is utilized for a six panel hexagonal enclosure.

Additionally, eight supports having 135 degree included angled slots can be used to create an octagonal enclosure 78, and six support having 120 degree included angled slot can be used to create a hexagonal enclosure 76 with six panels.

The combination eight and six support slots 50 design, as shown in FIG. 19, allows a single support to be utilized for both an eight panel octagonal shaped enclosure (as well as a square or rectangle) and a six panel hexagonal shaped enclosure (as well as a triangle or rectangle).

The eight into six slots special support allows the last three panels of an eight panel enclosure to be accordion folded against each other to form a six panel enclosure which, using the special support, can be formed into the hexagon, triangle or rectangle enclosures. To use the special eight into six slots support, a person will have to fold over, accordion style, the last three panels of an eight panel enclosure to form a six panel enclosure. The folded panels, which will be three times as thick as the other panels, fit into the wider panel slot on the special eight into six slots support. Two of these supports could be used in place of two of the six support in the previously disclosed hexagonal design. Also, if two of the eight into six panels support are used, two panels of a triangular, rectangular or hexagonal enclosure can be folded back/over to create each respective enclosure shape.

The eight panel slots support design is the commercially preferred design as it appears that most commercially available enclosures consist of eight panels and most end users will be satisfied with simplicity of single support design. By having eight slots, a single slot design is included, as well as a two-slots cross-way design, four “L” slots designs, and 135-degree slots designs. By providing a single support 10 with all of the above slot designs, a person can quickly and easily assemble an enclosure having a selected shape. By simply turning the support 10 and changing the support's orientation, the angle of each panel can be selectively chosen. Additionally, by providing a single support 10 with multiple slot options, a person does not have to use multiple different slotted supports; a single support 10 can be used for all locations on an enclosure.

If a person desires to use a single support for both six and eight panel enclosures, the combination support is available either by itself for dedicated six or eight panel enclosures or together with two special eight into six slot support if the person wants the utility of using an eight panel enclosure for both eight and six panel shaped enclosures.

Regardless of the slot(s) orientation, at least two panels can be inserted to form a partial section of an enclosure of any shape. For example, a hexagonal support 64 can support at least two adjacent panels 32 in multiple orientations to form a partial section of a square, rectangular or hexagonal enclosure. By providing various slot orientations for use with single or multiple panel(s) the utility and versatility of the support 10 is significantly increased.

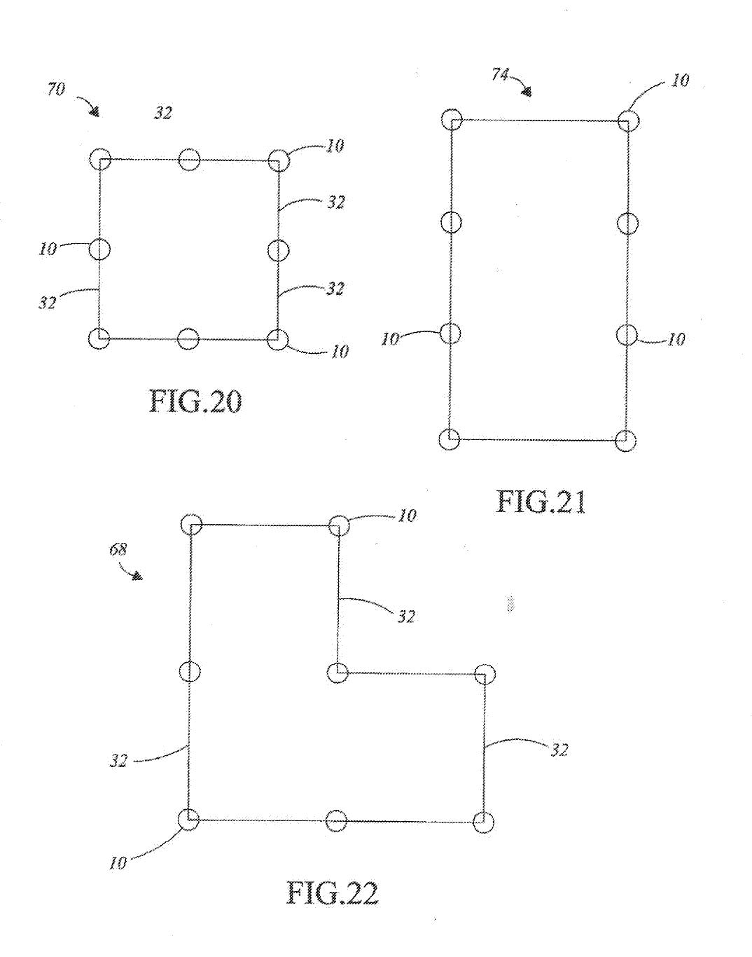

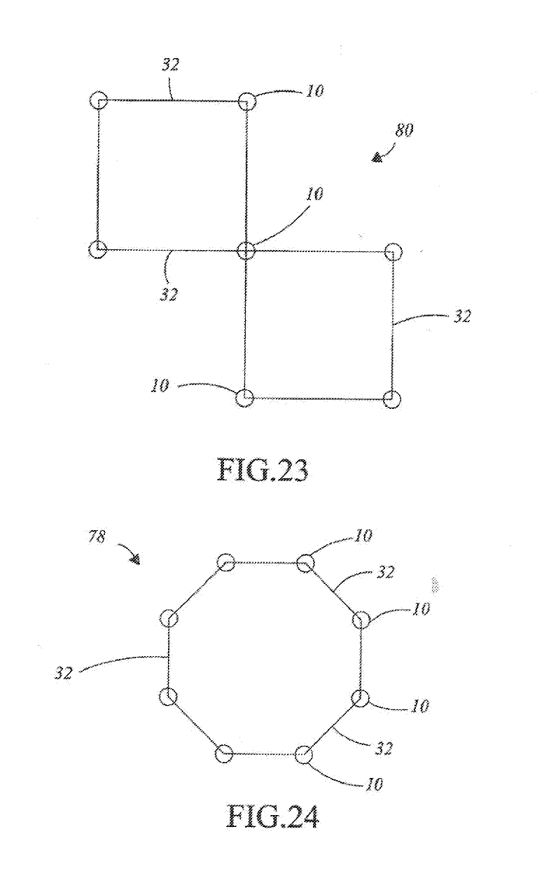

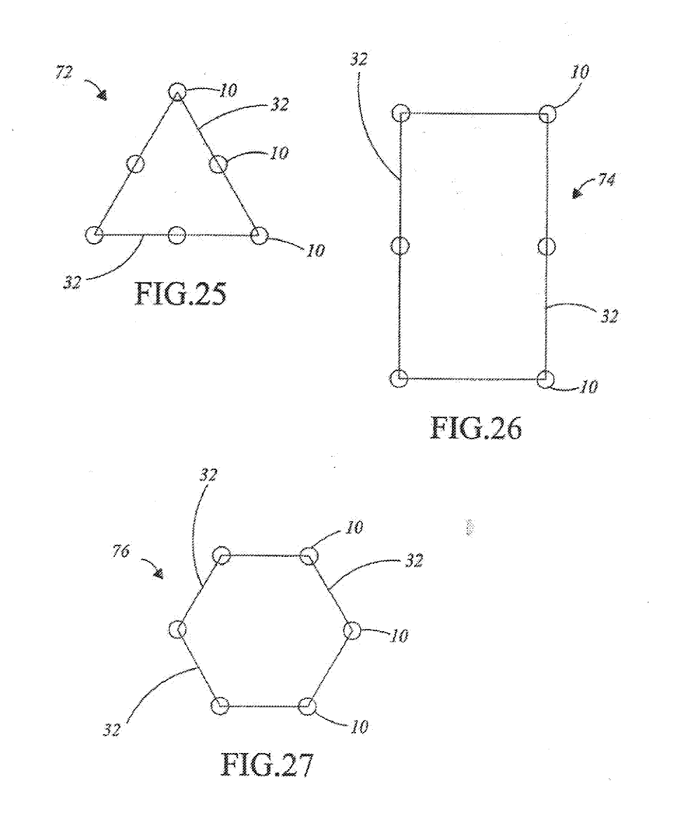

A portion of the lower edge 36 of a panel 32 is inserted into one of the slots 20, as shown in FIGS. 6, 7 and 8. The slot that is used is chosen based on the design of the enclosure being assembled, and the location of each respective support and panel in the design. Once a panel 32 is inserted into a slot, the panel is securely maintained in an upright position. Depending on the size and shape of the enclosure being assembled, multiple supports 10 and panels 32 are utilized. For example, a basic small square shaped enclosure 70 will utilize four supports, one at each corner, and four panels 32, one at each side. Each support will support an end portion of the lower edge of one of two panels, with the two panels extending outward at a 45-degree angle from each other. Examples of various support and enclosure shapes include: an eight support, eight panel square enclosure 74, as shown in FIG. 20; an eight support, eight panel rectangular enclosure, as shown in FIG. 21; an eight support, eight panel “L” shaped enclosure, as shown in FIG. 22; an eight support, eight panel dual square enclosure, as shown in FIG. 23; an eight support, eight panel octagonal enclosure, as shown in FIG. 24; a six support, six panel triangular enclosure, as shown in FIG. 25; a six support, six panel rectangular enclosure, as shown in FIG. 26 and a six support, six panel octagonal enclosure, as shown in FIG. 27.

As shown in FIGS. 20-27, larger enclosures of different geometric shapes will require multiple supports and panels. Depending on the size and shape requirements of the enclosure, the number of slots in each support, and the respective angle of each slot relating to its location and proximity to other slots, can vary. Some examples of slot placement within a support include: two slots in cross-way orientation in a square support 58, as shown in FIG. 11; three slots in multiple orientations in a pentagonal support 60, as shown in FIGS. 13 and 14; two slots in cross-way orientation in an octagonal support 62, as shown in FIG. 15 and four slots in cross-way orientations in an octagonal support 62, as shown in FIG. 16.

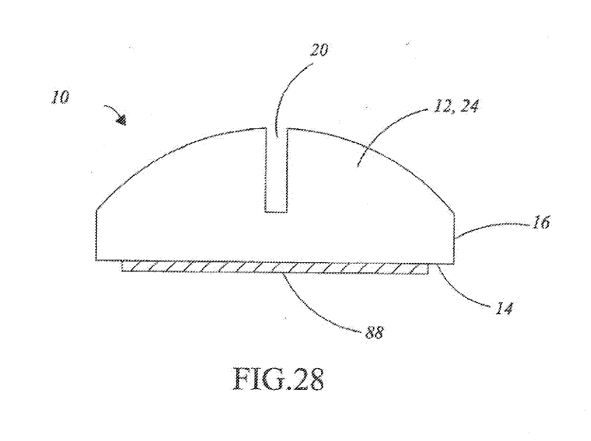

Additionally, to add stability to each support, and therefore to an entire enclosure, a non-slip material 88, as shown in FIG. 28, can be located the lower surface 14 of each support 10. The non-slip material 88 can be comprised of a non-slip tape that is applied and held by an adhesive backing, a non-slip coating that is applied and then hardens to a non-slip surface, or other commercially available methods. As an added benefit, a non-slip material further protects indoor flooring. The base itself raises the lower edge(s) of the enclosure off the floor, thereby maintaining the lower edge(s) at a height above any accumulated fluid on the floor. The addition of the non-slip coating further protects both the enclosure edges and the floor.

Once the total number of required panels are inserted into the slots on the supports and the enclosure structure is built, the sides of the panels are secured together by attachment means. Again, depending on the size and shape of the enclosure, the panel attachment means can be comprised of clips, wire or other devices that are integrally attached to the panel, or are a separate component. Typically, these panel attachment means are well known in the prior art.

While the invention has been described in detail and pictorially shown in the accompanying drawings it is not to be limited to such details, since many changes and modification may be made to the invention without departing from the spirit and the scope thereof Hence, it is described to cover any and all modifications and forms which may come within the language and scope of the claims.

1. A support base for a vertical section, wherein said base comprises an upper surface, a lower surface and a vertical perimeter edge, wherein the upper surface having at least one slot into which a lower edge of the vertical section is inserted and maintained, wherein multiple support bases are used in combination with multiple vertical sections to assemble a geometric structure that is placed upon a substantially flat surface.

2. The support base for a vertical section as specified in claim 1 wherein said base is made of a material selected from the group consisting of plastic, wood, metal and a synthetic material.

3. The support base for a vertical section as specified in claim 1 wherein said base has a circular shape with a domed upper surface.

4. The support base for a vertical section as specified in claim 1 wherein said base has a geometric shape that is selected from the group consisting of triangular, square, pentagonal, hexagonal, octagonal and a non-geometric shape.

5. The support base for a vertical section as specified in claim 1 wherein said at least one slot extends across said upper domed surface from one perimeter edge to an opposite perimeter edge.

6. A support base for a vertical section, wherein said base comprises an upper surface, a lower surface and a vertical perimeter edge, wherein said upper surface having at least two slots into each of which is inserted a lower edge of the vertical section, thereby maintaining the vertical section in an upright position, wherein multiple support bases are used in combination with multiple vertical sections to assemble a structure that is placed upon a substantially flat surface.

7. The support base for a vertical section as specified in claim 6 wherein said base is made of a material selected from the group consisting of plastic, wood, metal and a synthetic material.

8. The support base for a vertical section as specified in claim 6 wherein said base has a circular shape with a domed upper surface.

9. The support base for a vertical section as specified in claim 6 wherein said base has a geometric shape that is selected from the group consisting of triangular, square, pentagonal, hexagonal, octagonal and a non-geometric shape.

10. The support base for a vertical section as specified in claim 6 wherein the vertical section is comprised of a panel having an upper edge, a lower edge, a first side edge and a second side edge.

11. The support base for a vertical section as specified in claim 10 wherein the panel is made of a material selected from the group consisting of metal, plastic, wood and a synthetic material.

12. The support base for a vertical section as specified in claim 8 wherein the panel material is a mesh design.

13. The support base for a vertical section as specified in claim 6 wherein said at least one slot extends across said upper domed surface from one perimeter edge to an opposite perimeter edge.

14. The support base for a vertical section as specified in claim 13 wherein said at least two slots are in a cross-way orientation, 180-degrees from each other.

15. The support base for a vertical section as specified in claim 13 wherein said at least two slots are parallel to each other.

16. The support base for a vertical section as specified in claim 6 wherein said base is comprised of eight slots that are orientated to allow multiple vertical sections to be inserted at selected angles, thereby allowing the creation of a selected geometric or non-geometric shaped enclosure, wherein the eight slots in the one base allow a single base to be utilized in one of multiple positions when assembling an enclosure, thereby precluding the need for multiple bases each having a unique slots configuration for placement at a specific location during the enclosure assembly.

17. The support base for a vertical section as specified in claim 6 wherein the structure that is created is selected from the shape group consisting of triangular, square, pentagonal, hexagonal, and octagonal.

18. The support base for a vertical section as specified in claim 16 wherein the structure is utilized as an animal enclosure.

19. The support base for a vertical section as specified in claim 6 further comprising at least one slot that extends to a substantial mid-point on said upper domed surface.

20. A support base for a vertical section, wherein said base comprises a domed upper surface, a lower surface and a vertical perimeter edge, wherein the vertical section comprises a panel with an upper edge, a lower edge, a first side edge, and a second side edge, wherein said base's domed upper surface having at least one slot into which is inserted a portion of the panel's lower edge, thereby maintaining the panel in an upright position, wherein multiple support bases are used in combination with multiple panels to assemble a structure that is placed upon a substantially flat surface.

21. The support base for a vertical section as specified in claim 19 wherein the geometric structure is utilized as an animal enclosure.

22. The support base for a vertical section as specified in claim 19 further comprising a non-slip material that is located on the lower surface of said base.
